(19) United States
(12) Patent Application Publication
(10) Pub. No.: US 2026/0059161 A1
(43) Pub. Date: Feb. 26, 2026

(54) MULTIVIEW OF OVER-THE-AIR (OTA) STREAM AND OVER-THE-TOP (OTT) STREAM

(71) Applicant: DISH Network L.L.C., Englewood, CO (US)

(72) Inventor: Levi Boscardin, Denver, CO (US)

(21) Appl. No.: 18/812,789

(22) Filed: Aug. 22, 2024

(51) Int. Cl. H04N 21/43; H04N 21/426; H04N 21/431; H04N 21/438; H04N 21/462

(52) U.S. Cl. CPC H04N 21/43072; H04N 21/42607; H04N 21/4312; H04N 21/4383; H04N 21/4622

(57) ABSTRACT

Systems, media devices, and methods are provided. An example media device includes an over-the-air (OTA) receiver and an over-the-top (OTT) receiver. The OTA receiver is configured to tune a tuner to an OTA channel and receive an OTA stream corresponding to the OTA channel. The OTT receiver is configured to receive an OTT stream. Each one of the OTA stream and the OTT stream includes a video stream and an audio stream. The media device is configured to output the video streams of the OTA stream and the OTT stream to a display device according to a multiview layout template selected by the user. The multiview layout template includes a first window and a second window. The media device is configured to cause the video streams of the OTA stream and the OTT stream to be concurrently presented in the first window and the second window, respectively.

### BACKGROUND OF THE INVENTION

Generally, an over-the-air (OTA) or satellite television (TV) broadcast system provides OTA streams (e.g., video, audio, and/or other data transport streams) for a TV program. An internet-based streaming system provides over-the-top (OTT) streams (e.g., Internet Protocol TV streams or IPTV streams) for an OTT program. Traditionally, a single program is viewed on a single graphic device at a given time. However, it may be advantageous to display multiple concurrent programs on the same graphic display at the same time.

### BRIEF SUMMARY OF THE INVENTION

According to some embodiments of the present disclosure, media devices are provided. In one example, a media device includes an over-the-air (OTA) receiver, an over-the-top (OTT) receiver, one or more processors, and a computer-readable storage media storing computer-executable instructions. The OTA receiver further includes a tuner. The instructions when executed by the one or more processors cause the media device to tune the tuner to an OTA channel selected by a user to receive an OTA stream corresponding to the OTA channel and to cause the OTT receiver to receive an OTT stream. Each one of the OTA stream and the OTT stream further includes a video stream and an audio stream. The instructions when executed by the one or more processors further cause the media device to output the video stream of the OTA stream and the video stream of the OTT stream to a display device of a media presentation device, according to a multiview layout template selected by the user. The multiview layout template includes a first window and a second window. The instructions when executed by the one or more processors further cause the media device to cause the video stream of the OTA stream and the video stream of the OTT stream to be concurrently presented in the first window and the second window, respectively.

In another example, a media device includes an over-the-air (OTA) receiver, an over-the-top (OTT) receiver, one or more processors, and a computer-readable storage media storing computer-executable instructions. The OTA receiver further includes a plurality of tuners. The instructions when executed by the one or more processors cause the media device to tune the tuner to tune, respectively, a first tuner and a second tuner of the plurality of tuners to a first OTA channel and a second OTA channel selected by a user and receive a first OTA stream and a second OTA stream respectively corresponding to the first and second OTA channel. Each one of the first and second OTA streams further includes a video stream and an audio stream. The instructions when executed by the one or more processors further cause the OTT receiver to receive a first OTT stream. The first OTT stream corresponds to a first OTT channel selected by the user and further includes a video stream and an audio stream. The instructions when executed by the one or more processors further cause the media device to output the video streams of the first and second OTA streams and the video stream of the first OTT stream to a display device of a media presentation device, according to a multiview layout template selected by the user. The multiview layout template includes a first window, a second window, and a third window. The instructions when executed by the one or more processors further cause the video streams of the first and second OTA streams and the video stream of the first OTT stream to be concurrently presented in the first, second, and third window, respectively.

According to some embodiments of the present disclosure, a method performed by a media device is provided. In one example, the method includes tuning, by a first tuner and a second tuner of the media device, to a first OTA channel and a second OTA channel selected by a user and receiving a first OTA stream and a second OTA stream respectively corresponding to the first and second OTA channel. Each one of the first and second OTA streams includes a video stream and an audio stream. The method further includes receiving, by an OTT receiver of the media device, a first OTT stream corresponding to a first OTT channel selected by the user and comprising a video stream and an audio stream. The method further includes outputting the video streams of the first and second OTA streams and the video stream of the first OTT stream to a display device of a media presentation device, according to a multiview layout template selected by the user. The multiview layout template includes a first window, a second window, and a third window. The method further includes causing the video streams of the first and second OTA streams and the video stream of the first OTT stream to be concurrently presented in the first, second, and third window, respectively.

In accordance with some embodiments, the present disclosure also provides a non-transitory machine-readable storage medium encoded with instructions, the instructions executable to cause one or more electronic processors of a media device to perform any one of the methods described in the present disclosure.

### BRIEF DESCRIPTION OF THE DRAWINGS

FIG. 1 illustrates an embodiment of a media content delivery system.

FIG. 2 illustrates an exemplary system architecture of a media content delivery system according to embodiments described herein.

FIGS. 3A-3D respectively illustrate examples of multiview of media streams according to embodiments described herein.

FIG. 4 illustrates an exemplary view of a user interface for multiview according to embodiments described herein.

FIG. 5 illustrates a method for multiview of media streams according to embodiments described herein.

FIG. 6 illustrates a method for multiview of media streams according to embodiments described herein.

FIG. 7 illustrates an embodiment of a computer device or computer system according to embodiments described herein.

### DETAILED DESCRIPTION OF THE INVENTION

Traditional mosaic multiview systems often generate a single media stream by combining multiple individual media streams into a fixed grid layout. For example, multiple pre-determined OTA feeds are mixed and integrated to generate a single OTA feed according to a preset mosaic configuration. The single OTA feed is encoded and transmitted to the media device. The media device decodes the single OTA feed and convert it into a single OTA stream. The single OTA stream is then output to a display device to allow presentation of a mosaic of smaller video windows according to the preset mosaic configuration.

One limitation of traditional mosaic multiview systems is the static nature of the predetermined channels (e.g., OTA feeds). Once the channels for the individual streams within the single stream are set, they cannot be changed by the user during presentation. Thus, users are locked into viewing the preset streams, with no ability to switch to different channels or sources dynamically. Additionally, the fixed grid layout provides no customization options for users. The layout (e.g., number, position, size, etc.) of the windows is preset and cannot be altered without a complete reconfiguration of the single stream. Further, the traditional mosaic multiview systems are often designed to handle one type of signal source (e.g., only OTA or satellite signals), which disables the users to mix and match streams from different sources within the same multiview layout.

Picture-in-picture (PiP) functionality enables users to tailor their viewing experience by selecting and configuring their preferred channels. PiP allows users to simultaneously watch multiple streams by combining them into a single viewing interface. Traditional PiP, however, is limited to combining streams of the same type, such as OTT streams or OTA streams, but not both types together.

The present disclosure provides techniques to address at least the above challenges. According to some embodiments, a media device is provided. The media device includes an OTA receiver that further includes multiple tuners, an OTT receiver configured to receive OTT feeds from content resources, one or more processors, and a computer-readable storage media storing computer-executable instructions. The instructions enable the media device to tune respectively a first tuner and a second tuner of the multiple tuners to a first OTA channel and a second OTA channel selected by a user and receive a first OTA stream and a second OTA stream respectively corresponding to the first and second OTA channel. Each one of the first and second OTA streams includes a video stream and an audio stream. The instructions further enable the media device to receive an OTT stream corresponding to an OTT channel selected by the user and including a video stream and an audio stream, output the video streams of the first and second OTA streams and the video stream of the first OTT stream to a display device of a media presentation device, according to a multiview layout template selected by the user. The multiview layout template comprising a first window, a second window, and a third window. The instructions further enable the media device to cause the video streams of the first and second OTA streams and the video stream of the first OTT stream to be concurrently presented in the first, second, and third window, respectively.

The media device and multiview system according to the present disclosure allows users to independently select and switch OTT or OTA channels for each window within a customizable multiview layout. The present media device and multiview system also supports various multiview templates and enables adjustments to the number and arrangement of windows to provide a personalized viewing experience. The present media device and multiview system also allow for simultaneous multiview presentations of media streams from various sources beyond OTA and OTT channels, such as live camera feeds, pre-recorded media content, video game streams, etc., concurrently with the presentation of OTA and/or OTT streams in the multiview layout. The present media device and multiview system allows the user to selectively record a media stream of one window of the multiview layout or simultaneously record multiple streams from different selected windows without requiring excessively powerful processing units.

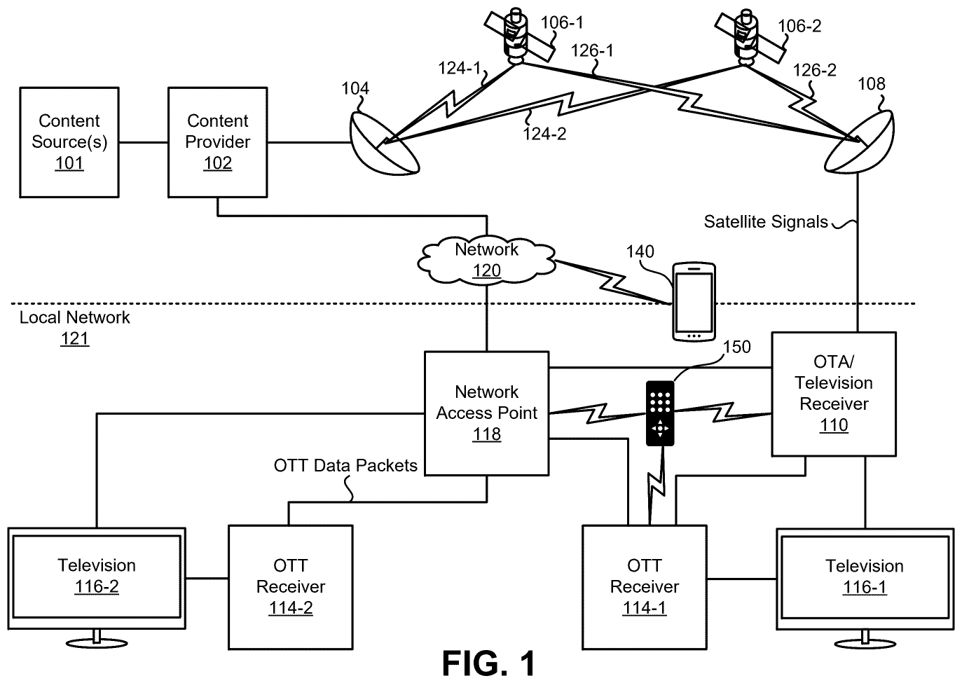

Further detail regarding multiview of both OTA streams (i.e., satellite TV streams) and OTT streams (i.e., IPTV streams) on one display is provided in relation to the figures. FIG. 1 illustrates an embodiment of a media content delivery system. For brevity, system 100 is depicted in a simplified and conceptual form and may generally include more or fewer systems, devices, networks, and/or other components as desired. Further, the number and type of features or elements incorporated within system 100 may or may not be implementation-specific, and at least some of the aspects of system 100 may be a combination of an OTA content delivery system and an IPTV (Internet Protocol Television) content distribution system. In some embodiments, the system 100 may further includes a cable TV content distribution system and/or any other type of media or content distribution system.

System 100 may include at least one network 120 that may facilitate bi-directional communication for data transfer between devices connected to network access point 118 and content provider 102. Additionally, or alternatively, network 120 may facilitate bi-directional communication for data transfer between content source(s) 101 and content provider 102. Network 120 is intended to represent any number of terrestrial and/or non-terrestrial network features or elements. For example, network 120 may incorporate or exhibit any number of features or elements of various wireless and/or hardwired packet-based communication networks such as, for example, a WAN (Wide Area Network) network, a HAN (Home Area Network) network, a LAN (Local Area Network) network, a WLAN (Wireless Local Area Network) network, the Internet, a cellular network, or any other type of communication network within which data may be transferred between and among respective components of the system 100.

System 100 may also include at least one local network 121 that establishes a bi-directional communication path for data transfer between and among television receiver 110 (also referred to as OTA receiver or OTA device), network access point 118, OTT receivers 114 (also referred to as OTT device), televisions 116, mobile device 140, and/or one or more personal or business computing devices, such as local media servers, personal computers, or the like. Local network 121 may correspond to a home or business computing environment. Television receiver 110, together with OTT receivers 114 and televisions 116, may each be incorporated within or form at least a portion of a particular home or business computing network.

Television receiver 110 and OTT receivers 114 may correspond to television receivers and/or television converters, such as a set-top box (STB) for example, or smart TV content receivers. In another example, television receiver 110 and OTT receivers 114 may exhibit functionality integrated as part of or into a television; a DVR (Digital Video Recorder); a computer, such as a tablet computing device; or any other computing system or device, as well as variations thereof. Further, television receiver 110 may be able to communicate with other devices in accordance with various communication protocol(s) and/or standard(s) including, for example, TCP/IP (Transmission Control Protocol/Internet Protocol), DLNA/DTCP-IP (Digital Living Network Alliance/Digital Transmission Copy Protection over Internet Protocol), HDMI/HDCP (High-Definition Multimedia Interface/High-bandwidth Digital Content Protection). For example, as disclosed further herein, one or more of the various elements or components of the at least one local network 121 may communicate using TCP/IP using one or more wireless techniques, such as Wi-Fi; or wired techniques, such as Ethernet or MoCA® (Multimedia over Coax Alliance). Still other embodiments are possible.

In practice, satellites 106 may each receive uplink signals 124 from satellite uplink 104. In this example, each of uplink signals 124 may contain one or more transponder streams of particular data or content, such as one or more particular television channels, as supplied by content provider 102. For example, each of the respective uplink signals 124 may contain various media content from content source(s) 101, such as encoded HD (High Definition) television channels, SD (Standard Definition) television channels, regional broadcast channels, on-demand programming, programming information, and/or any other content in the form of at least one transponder stream, in accordance with an allotted carrier frequency and bandwidth. In this example, different media content may be carried using different versions of satellites 106.

Satellites 106 may further relay uplink signals 124 to satellite dish 108 as downlink signals 126. Similar to uplink signals 124, each of downlink signals 126 may contain one or more transponder streams of particular data or content, such as various encoded and/or at least partially electronically scrambled television channels and/or on-demand programming, in accordance with an allotted carrier frequency and bandwidth. Downlink signals 126, however, may not necessarily contain the same or similar content as a corresponding one of uplink signals 124. For example, uplink signal 124-1 may include a first transponder stream containing at least a first group or grouping of television channels, and downlink signal 126-1 may include a second transponder stream containing at least a second, different group or grouping of television channels. In other examples, the first and second group of television channels may have one or more television channels in common. In sum, there may be varying degrees of correlation between uplink signals 124 and downlink signals 126, both in terms of content and underlying characteristics. Further, satellite television signals may be different from broadcast television or other types of signals. Satellite signals may include multiplexed, packetized, and modulated digital signals. Once multiplexed, packetized and modulated, one analog satellite transmission may carry digital data representing several television stations or service providers. Some examples of service providers include HBO®, CBS®, and/or ESPN®.

Satellite dish 108 may be provided to receive television channels (e.g., on a subscription basis) provided by content source(s) 101 and/or content provider 102, satellite uplink 104, and/or satellites 106. For example, satellite dish 108 may be receive particular transponder streams, or downlink signals 126, from one or more of satellites 106. As another example, satellite dish 108 may provide a plurality of television channel frequencies to a television frequency tuner of television receiver 110. Additionally, television receiver 110, which is communicatively coupled to satellite dish 108, may subsequently select via a tuner, decode, and relay particular transponder streams to television 116-1 for display thereon. For example, satellite dish 108 and television receiver 110 may, respectively, receive, decode, and relay at least one television channel to television 116-1. As another example, television receiver 110 may tune a television frequency tuner to a television channel frequency of a plurality of television channel frequencies received by satellite dish 108. Programming or content associated with the channel may generally be presented live, or from a recording as previously stored on, by, or at television receiver 110. Here, the channel may be output to television 116-1 in accordance with the HDMI/HDCP content protection technologies. However, other embodiments are possible. For example, the channel may be output to television 116-1 in accordance with the MoCA® (Multimedia over Coax Alliance) home entertainment networking standard. As another example, the channel may be output to television 116-1 in accordance with the Transmission Control Protocol (TCP) and/or Internet Protocol (IP) via network access point 118 over local network 121. In yet another example, the channel may be output to television 116-1 via a wired network connection over a private network containing television 116-1 and television receiver 110.

Further, television receiver 110 may select via a tuner, decode, and relay particular transponder streams to one or both of OTT receivers 114 which may in turn relay particular transponder streams to a corresponding television of televisions 116 for display thereon. For example, satellite dish 108 and television receiver 110 may, respectively, receive, decode, and relay at least one television channel to television 116-1 by way of OTT receiver 114-1. Additionally, or alternatively, television receiver 110 may select via a tuner, decode, and relay particular transponder streams directly to televisions 116, personal computer 150, and/or mobile device 140 for display thereon. Similar to the above-example, television channels may be presented live, or from a recording as previously stored on television receiver 110, and may be output to television 116-1 by way of OTT television receiver 114-1 in accordance with a particular content protection technology and/or networking standard.

Relaying transponder streams and/or digital content from television receiver 110 to televisions 116 via OTT receivers 114 may include transmission via wireless communication. For example, the at least one local network 121 may include a private content network. Television receiver 110 may then transmit digital content to OTT receivers 114 via the private content network. Additionally, or alternatively, relaying transponder streams and/or digital content from television receiver 110 to televisions 116 via OTT receivers 114 may include transmission via one or more wired connections. For example, television receiver 110 may be connected to OTT receivers 114 and/or televisions 116 via a networking cable, such as CAT-5, a coaxial cable, a universal serial bus (USB) cable, and the like.

In some embodiments, OTT receivers 114, televisions 116, personal computer 150, and/or mobile device 140 execute a client software application that includes a user interface for integrating live television content from television receiver 110 with the media content provided by content source(s) 101 and/or content provider 102. In some embodiments, the client functionality is provided by a Web site and is accessible by OTT receivers 114, televisions 116, personal computer 150, and/or mobile device 140 via a Web browser. When any of the devices wish to connect to a stream of television receiver 110 using the client application or via a Web browser interface, it may specify an IP address associated with television receiver 110 to access and pull the media stream from television receiver 110. This action sends a request to television receiver 110, and the request travels across local network 121 and/or network 120 (e.g., the public Internet) to television receiver 110.

OTT receivers 114, televisions 116, mobile device 140, and/or personal computer 150 may receive digital content from content source(s) 101 and/or content provider 102 via network 120. For example, while television receiver 110 may receive satellite television channels via satellite dish 108 and provide them to OTT receivers 114, OTT receivers 114 may also access network 120 via network access point 118, as described below, to stream digital content from content provider 102 and/or one or more OTT provider(s) directly, or via content provider 102, such as Netflix®, Spotify®, Google®, YouTube®, Disney®, Hulu®, Peacock®, etc. and relay the digital content to televisions 116 for display thereon. While described as streaming content, OTT receivers 114 may also transmit, receive, or otherwise have access to, other forms of data such as documents, databases, websites, email, search engine results, digital assistant interfaces, and the like.

For example, OTT receivers 114, televisions 116, mobile device 140, and/or television receiver 110 may collect various usage and/or user data. As described herein, usage data may include information identifying content provided to a user, such as individual media content titles, preferred genres, or the like. Additionally, or alternatively, usage data may include information related to interactions and/or input from a user via one or more user interfaces, such as a graphical user interface (GUI), a voice user interface (VUI), or the like. For example, usage data may include commands received via one or more user interfaces to control an operation of a device, such as when requesting particular media content. Additionally, or alternatively, usage data may include the raw and/or processed inputs used to generate such commands, such as raw and/or processed audio data from a voice enabled remote control, such as personal computer 150, search query terms and/or phrases typed into a GUI, or the like.

Users can control what usage and/or user data is provided to, derived, or otherwise obtained by devices, as well as how the data can be used. For example, user's may have access to one or more user interfaces accessible via mobile device 140, television receiver 110, OTT receivers 114, and/or televisions 116 to control their user profile privacy settings. As described further herein, such user interfaces may provide users with the option to provide user data, such as age, language, and preferred content settings. Additionally, or alternatively, such user interfaces may allow users to define what tertiary data, such as usage data, can be used to derive user data and/or the user data that can be derived. In some embodiments, usage and/or user data is maintained by local devices, such as television receiver 110, without transmitting such data outside of local network 121. As described further herein, maintaining usage and/or user data locally may reduce the risk of unauthorized access. Locally maintained usage and/or user data may further enable more efficient and/or accurate media content individualization. In some embodiments, usage and/or user data may be securely transmitted to content provider 102 for storage in association with a user account maintained by content provider 102. Subsequently, such usage and/or user data may be accessed by one or more processes and/or services provided by content provider 102 may individualize media content based on the usage and/or user data before transmission to a requesting device.

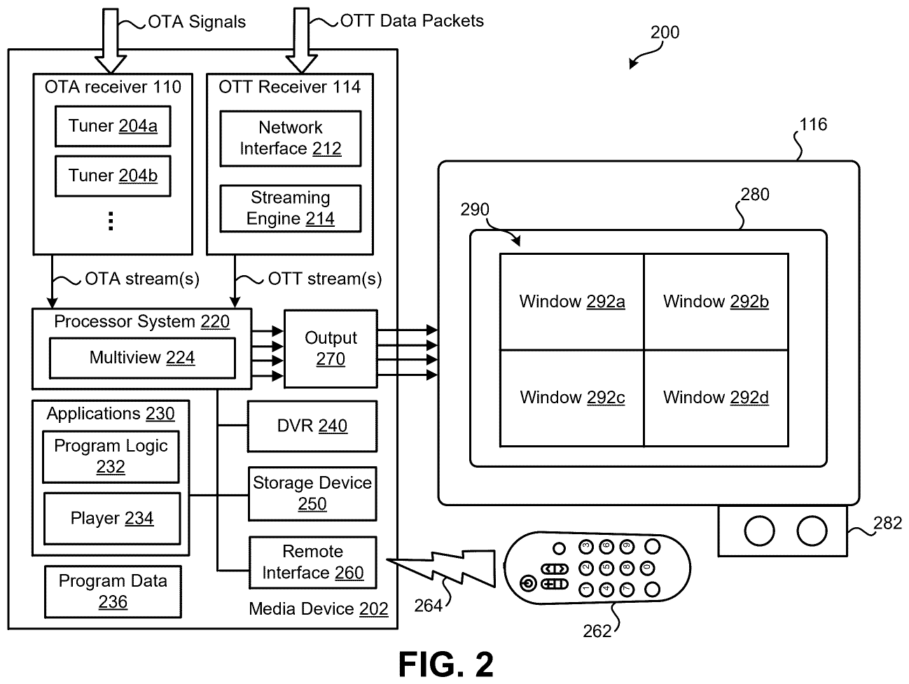

OTT receivers 114, televisions 116, mobile device 140, and/or personal computer 150 may access content from content provider 102 via one or more web-based applications. In some embodiments, such web-based applications may include user interfaces that enable a user to access and view live programming provided by regional broadcast television channels via television receiver 110 from within the web-based application. Additionally, or alternatively, OTT receivers 114 may provide one or more user interfaces that enable a user to integrate television receiver 110 as a television content input for OTT receivers 114, which may then be added via a user interface of a web-based application. For example, such user interfaces may enable a user to provide identifying information for television receiver 110, such as make and model information, network address information, user account information, and the like. In response, the web-based applications, and/or OTT receivers 114 may initiate a connection with television receiver 110 via local network 121. Subsequently, when television receiver 110 provides media content to OTT receivers 114 via local network 121, the media content may be displayed within the web-based applications of OTT provider(s) 102. In some embodiments, the television receiver 110 and the OTT receiver 114 may be integrated into a single media device (e.g., media device 202 of FIG. 2) configured to receive both satellite feeds of media content and OTT feeds of media content and respectively convert into satellite streams and OTT streams for display on the television 116 for multiview.

Network access point 118 may function similar to a wireless router. For example, network access point 118 may receive digital communication from television receiver 110 and route the digital communication to an intended recipient of OTT receivers 114, televisions 116, personal computer 150, and mobile device 140. Network access point 118 may receive the digital communication via a wired connection from television receiver 110, such as via an Ethernet or MoCA® connection. Network access point 118 may then transmit the digital communication to the appropriate recipient via a wireless communication standard, such as Wi-Fi, Bluetooth®, ZigBee®, or the like. Additionally, network access point 118 may receive wireless communication from any of OTT receivers 114, televisions 116, personal computer 150, and mobile device 140 and relay the communication to television receiver 110 via a wired or wireless connection. For example, OTT receiver 114-2 may transmit a request to television receiver 110 via network access point 118 for live television media content corresponding to one of the transponder streams.

As described further below, the at least one local network 121 may include one or more general networks or general-purpose networks. General networks may function in a similar manner, or for a similar purpose, as home or business local area networks configured to provide network access to a wide array of electronic devices for general purpose computing, such as email, web-browsing, and the like. Network access point 118 may establish, or otherwise provide access to, the general network. For example, network access point 118 may be a wired or wireless router or switch device configured to receive and distribute data from and to various devices coupled with it and/or between other networks, such as network 120. After connecting to network access point 118, the various electronic devices may transmit and/or receive data via the general network. In some embodiments, a general network is defined as a network which a user explicitly authorizes devices to use for communication by providing a password and SSID, or other access credentials. In contrast, access to private networks, such as those described below, may be managed by a device such as television receiver 110, and users may be otherwise unable to directly provide access credentials to such a network.

FIG. 2 illustrates an exemplary system architecture of a media content delivery system 200 according to embodiments described herein. System 200 may include one or more distributed devices and/or systems configured to provide media contents to the users. As described herein, media content may include audio media content, such as music, audiobooks, podcasts or the like. Media content may further include visual content, such as images, documents, text, social media, or the like. Further still, media content may include audio-visual content, such as movies, television shows, publicly shared video content, or the like.

In the illustrated example of FIG. 2, system 200 includes media device 202 and television 116. Media device 202 further includes an OTA receiver 110 and an OTT receiver 114. As described above, OTA receiver 110 is operable and configured to receive OTA/satellite signals and convert the OTA/satellite signals into OTA streams. On the other hand, the OTT receiver 114 is operable and configured to receive OTT data packets via network communication (e.g., an IP network) and convert the OTT data packets into OTT streams. In some embodiments, OTA receiver 110 and OTT receiver 114 are integrated in media device 202. In some embodiments, OTA receiver 110 and OTT receiver 114 are independent devices in communication with each other as well as the media device 202 via a wired connection or wireless connection. System 200 further includes, among other components, processor system 220, applications 230 stored in a memory of the media device 202, digital video recorder (DVR) 240, storage device 250, remote interface 260, and output engine/interface 270.

The OTA receiver 110 further includes at least one tuner 204. In some embodiments, the OTA receiver 110 includes a plurality of tuners 204 (e.g., 204a, 204b, 204c, 204d, etc.). In some embodiments, OTA receiver 110 includes at least 4 tuners 204. Each tuner 204 is configured to receive OTA/satellite radio frequency (RF) signals from satellite dish or antenna, select the desired channel frequency from the received OTA signals, and generate the required frequencies to tune into a desired OTA channel (e.g., an OTA channel selected by the user/viewer or in accordance with instructions received from the processor system 220). Each tuner 204 may further include one or more signal processing components, such as decoder, demultiplexer, etc., configured to convert the OTA signals into a transponder stream (e.g., an OTA stream) for the selected channel and relay the channel to the television 116 such that the OTA stream can be displayed on the television 116. In some embodiments, each tuner 204 can only tune into a single channel selected by the user.

The OTT receiver 114 may further include a network interface 212 and a streaming engine 214. The network interface 212 is operable and configured to establish and manage the connection to the network access points such that the OTT receiver 114 can receive data packets of the media content from content resources via the network. The streaming engine 214 may include a combination of hardware and software, such as buffering device, demultiplexer, decoder, DRM module, synchronization module, among others. For example, the buffering device is operable to temporarily store incoming data packets and manage variations in network speed. The demultiplexer is operable to separate the multiplexed OTT stream into individual audio, video, and metadata streams. The decoder is operable to decode compressed video and audio streams using supported codecs. The DRM module is operable to decrypt DRM-protected media content using pre-established DRM decryption keys. The synchronization module is operable to synchronize the audio and video streams in one OTT stream for playback. The streaming engine 214 is operable to convert data packets into one or more OTT streams respectively for one or more OTT channels selected by the user.

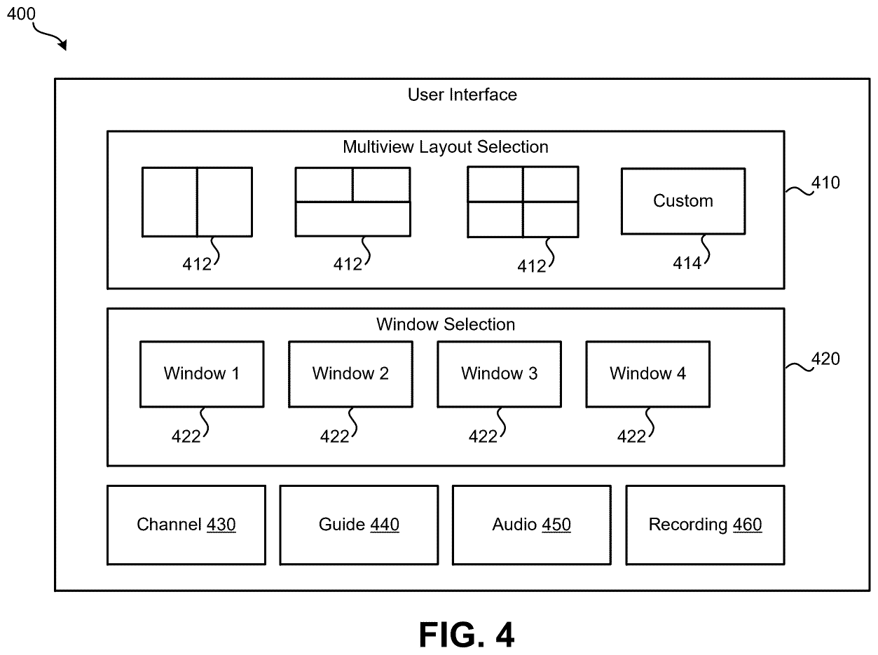

In the illustrated example, the processor system 220 further includes a multiview engine 224 operable and configured to further process the OTA streams and OTT streams for concurrent streaming in a multiview mode for output. In some embodiments, the multiview engine 224 further includes a multiview layout manager, an integration module, a synchronization module, an audio stream filter, and a rendering engine. The multiview layout manager is determines and manages the visual arrangement of multiple video streams in the multiview mode and supports dynamic changes to the multiview layout based on user input. The multiview layout manager may further include a layout configuration module configured to generate, store, and apply various multiview layout templates (e.g., the visual templates 412 of FIG. 4). The integration module is configured to integrate the OTA streams and OTT streams corresponding to the selected channels by the user for the selected multiview layout. The synchronization module is configured to synchronize all video streams for coherent playback and aligns the playback timing of streams from different content resources. The audio stream filter may include an audio stream selector configured to select the appropriate audio stream of a media stream (e.g., OTA stream or OTT stream) based on user input for output and filter out the audio streams from other media streams.

Applications 230 further includes program logic 232 and media player 234. Program logic 232 includes stream management logic executable by the multiview engine 224 to manage the selection, integration, and switching of OTA streams and OTT streams for multiview, such that the OTA/OTT streams corresponding to the selected channels by the user are correctly processed and presented according to user preferences and the selected multiview layout. The program logic 232 further includes user interaction logic executable to process user inputs to control and adjust the multiview features such that the changes made by the user are reflected in the multiview. The program logic 232 further includes synchronization logic executable to synchronize playback of integrated OTA/OTT streams and manage the switching between OTT/OTA streams and alignment of audio and video streams from different content sources.

The media player 234 is configured to control playback of each one of the OTA/OTT streams of the multiview based on user input. The media player 234 interprets user inputs, which could include commands to start, stop, pause, resume, or switch between OTA and OTT streams in the multiview. The media player 234 is integrated within the multiview interface and manages each OTA and OTT stream individually or collectively based on user interactions. For example, the media player 234 allows the user to synchronize all OTA and OTT streams selected for display in terms of playback start, pause, and stop commands. The media player 234 also allows the user to select audio from specific streams and/or adjust audio volume independently for different streams. The media player 234 provides interactive controls within the multiview layout to allow users to interact directly with each displayed stream and provides customization of the playback of each media stream based on user preferences stored in program data 236, such as layout preferences or favorite channels. In some embodiments, the media player 234 can automatically adjust streaming quality (e.g., resolution, bitrate) based on OTA signal quality, network conditions, and/or user preferences for each one of the media streams for multiview and control buffering and reducing latency between streams when both OTA and OTT streams are displayed concurrently for multiview.

The program data 236 is stored in a memory of the media device 202 and can include channel data, correlation data, and user preference data. The channel data includes channel IDs, metadata associated with the channel, among others. Correlation data includes data indicating the correlation between OTT channel ID (e.g., channel number) and content resource and data indicating the correlation between OTA channel ID and tuner frequency. The data indicating the correlation between OTT channel ID and content resource further includes mapping data establishing links between OTT channel IDs and specific content resources or providers, data regarding the source or origin of OTT content, including provider names, URLs, or service identifiers, and authentication data required for accessing OTT content, such as authentication tokens or access credentials. The data indicating correlation between OTA channel ID and tuner frequency further includes mapping data establishing OTA channel IDs to specific tuner frequencies or RF signal parameters, tuner configuration data about settings for each tuner within the OTA receiver, including frequency bands, modulation types, and signal processing configurations, and signal reception metrics data on signal strength, quality indicators, and antenna settings associated with each OTA channel.

The program data 236 may further include user-customized or user-defined preferences for multiview layouts, including preferred arrangements of video windows on the multiview screen, settings related to audio output preferences, such as preferred audio channels, volume levels, and audio stream selection logic, language preference, favorite channels, playback quality preference, among others.

The DVR 240 is operable and configured to record live content of the OTA streams and OTT streams. For example, the DVR 240 can record live OTA broadcasts and capture audio-visual content from traditional broadcast signals received via antenna or satellite and record OTT streams received over IP networks. The DVR 240 further provides time-shifting capabilities to allow the users to control their viewing experience by temporarily storing live content for later playback. The DVR 240 also allows users to schedule recordings of specific programs or series on an OTA or OTT channel in advance and allow users to utilize Electronic Program Guides (EPGs) or user-defined timers to initiate recordings at specified times. In some embodiments, the DVR 240 may include an integrated recorder configured to simultaneously record both an OTA stream and an OTT stream concurrently presented in a multiview mode and store the recorded media content of the OTA or OTT streams in the storage device 250.

The exemplary media device 202 is configured to receive commands from a user via a remote control 262. The remote control 262 includes one or more controllers disposed on the surface of the remote control 262. The user, by actuating one or more of the controllers, causes the remote control 262 to generate and transmit commands, via a wireless signal 264, to the media device 202. The commands control the media device 202 and/or control the components of the system 200. The wireless signal 264 may be an infrared (IR) signal or a radio frequency (RF) signal that is detectable by the remote interface 260. The output engine/interface 270 is configured to output the OTA streams and OTT streams for multiview to a display or presentation device such as the television 160.

The television 160 may include a visual display device 280 and an audio presentation device or audio device 282. In some embodiments, the visual display device 280 may present a user interface showing a multiview screen 290 in the user interface. The multiview screen 290 may include a plurality of windows 292 (e.g., 292a, 292b, 292c, 292d, etc.) arranged according to a preestablished multiview layout template selected by the user/view. The number of the windows may vary, depending on the user selection, from 2 to 16. User may select a channel for each window such that a video stream of an OTA stream or an OTT stream corresponding to the selected channel is presented on the window, and all the videos streams are concurrently presented in multiple windows 292 of the multiview screen 290.

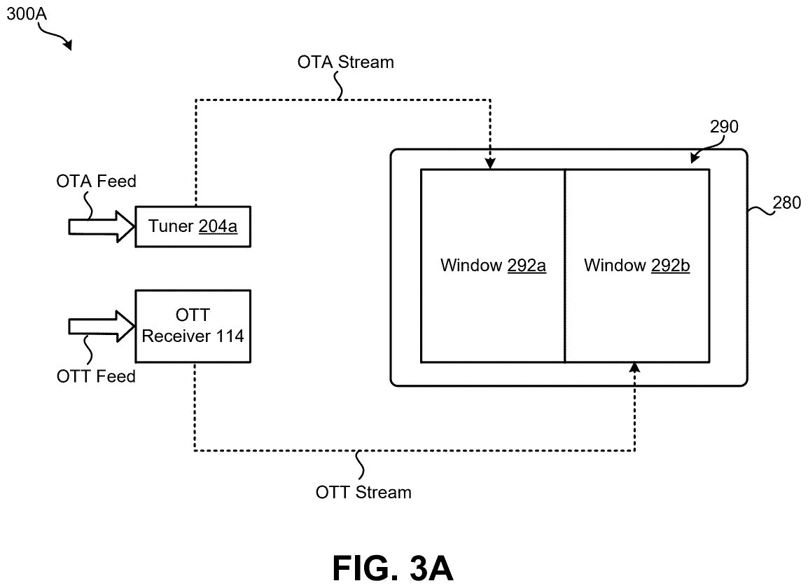

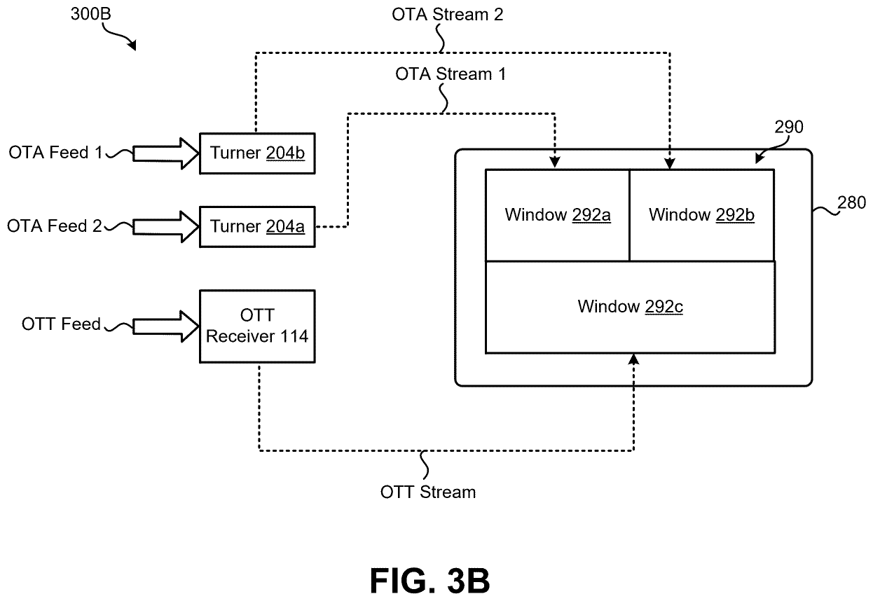

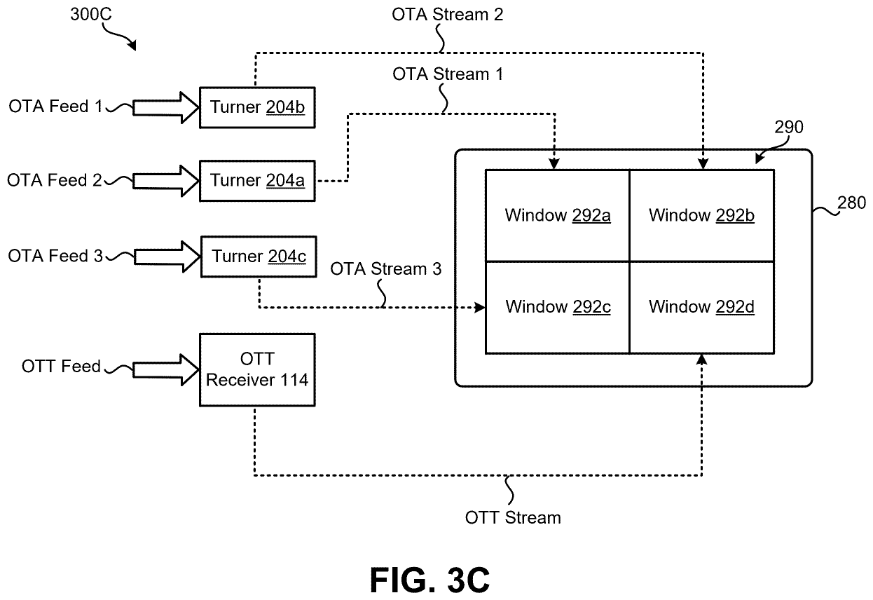

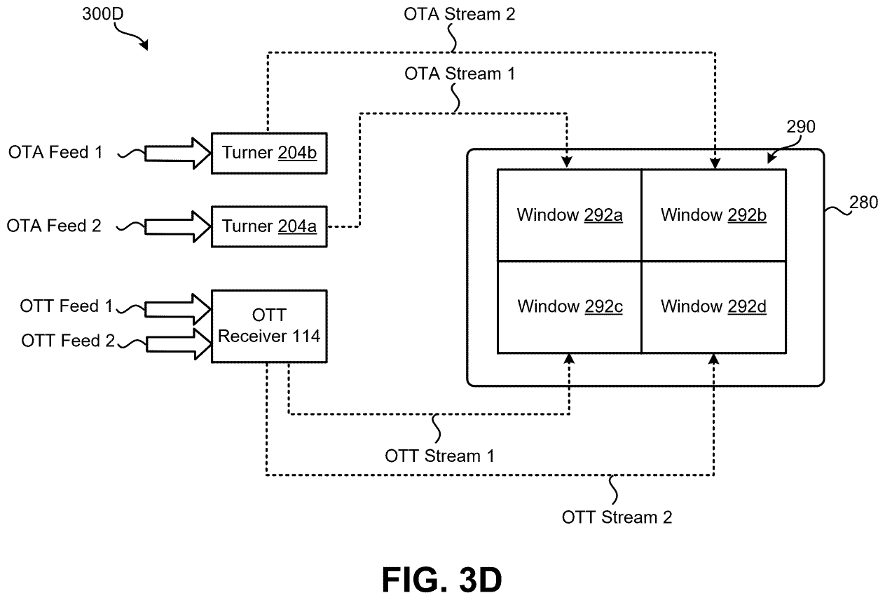

FIGS. 3A-3D illustrate various examples of implementation of system 200 for multiview of media streams. FIG. 3A illustrates an embodiment of a multiview 300A. The multiview screen 290 shows layout template including two windows 292a and 292b side-by-side. However, other variations of the arrangement of the two windows, such as vertical arrangement, are also possible. A tuner 204a of the media device 202 receives an OTA feed (i.e., OTA signals) and convert the OTA feed into an OTA stream. The OTA stream includes a video stream and an audio stream. The video stream of the OTA stream is output to the display device 280 and displayed on window 292a of the multiview screen 290. The OTT receiver 114 receives an OTT feed (i.e., OTT data packets) and convert the OTT feed into an OTT stream. The OTT stream includes a video stream and an audio stream. The video stream of the OTT stream is output to the display device 280 and displayed on window 292b of the multiview screen 290. One of the audio streams (e.g., either the OTT stream or the OTA stream but not both) may be output to the audio device 282 according to user input/selection. The presentation of the video streams of the OTA stream and the OTT stream may be synchronized. The video stream and the audio stream may also be synchronized.

FIG. 3B illustrates an embodiment of a multiview 300B. The multiview screen 290 shows layout template including three windows 292a, 292b, and 292c. However, other variations of the arrangement of the three windows, such as side-by-side or vertical arrangement, are also possible. A first tuner 204a of the media device 202 receives a first OTA feed and convert the first OTA feed into a first OTA stream. A second tuner 204b of the media device 202 receives a second OTA feed and convert the second OTA feed into a second OTA stream. Each OTA stream includes a video stream and an audio stream. The video streams of the first and second OTA streams are output to the display device 280 and respectively displayed the windows 292a and 292b of the multiview screen 290. The OTT receiver 114 receives an OTT feed and converts the OTT feed into an OTT stream. The OTT stream includes a video stream and an audio stream. The video stream of the OTT stream is output to the display device 280 and displayed on window 292c of the multiview screen 290. One of the audio streams (e.g., one of the first OTA stream, the second OTA stream, and the OTT stream) is output to the audio device 282 according to user input/selection. The presentation of the video streams of the first and second OTA streams as well as the OTT stream may be synchronized. The video stream and the audio stream may also be synchronized for the corresponding media stream.

FIG. 3C illustrates an embodiment of a multiview 300C. The multiview screen 290 shows a layout template including four windows 292a, 292b, 292c, and 292d. However, other variations of the arrangement of the four windows, such as side-by-side or vertical arrangement, are also possible. A first tuner 204a of the media device 202 receives a first OTA feed and convert the first OTA feed into a first OTA stream. A second tuner 204b of the media device 202 receives a second OTA feed and convert the second OTA feed into a second OTA stream. A third tuner 204c of the media device 202 receives a third OTA feed and convert the third OTA feed into a third OTA stream. In some embodiments, the OTA feeds received by the tuners may be output as OTA streams without further processing. Each OTA stream includes a video stream and an audio stream. The video streams of the first, second, and third OTA streams are output to the display device 280 and respectively displayed the windows 292a, 292b, and 292c of the multiview screen 290. The OTT receiver 114 receives an OTT feed and converts the OTT feed into an OTT stream. The OTT stream includes a video stream and an audio stream. The video stream of the OTT stream is output to the display device 280 and displayed on window 292d of the multiview screen 290. One of the audio streams (e.g., one of the first OTA stream, the second OTA stream, the third OTA stream, and the OTT stream) is output to the audio device 282 according to user input/selection. The presentation of the video streams of the first, second, and third OTA streams as well as the OTT stream may be synchronized. The video stream and the audio stream may also be synchronized for the corresponding media stream.

FIG. 3D illustrates an embodiment of a multiview 300D. The multiview screen 290 shows a layout template including four windows 292a, 292b, 292c, and 292d. However, other variations of the arrangement of the four windows, such as side-by-side or vertical arrangement, are also possible. A first tuner 204a of the media device 202 receives a first OTA feed and convert the first OTA feed into a first OTA stream. A second tuner 204b of the media device 202 receives a second OTA feed and convert the second OTA feed into a second OTA stream. Each OTA stream includes a video stream and an audio stream. The video streams of the first and second OTA streams are output to the display device 280 and respectively displayed the windows 292a and 292b of the multiview screen 290. The OTT receiver 114 receives a first OTT feed from a first content source and converts the first OTT feed into a first OTT stream. The OTT receiver 114 also receives a second OTT feed from a second content resource and converts the second OTT feed into a second OTT stream. Each OTT stream further includes a video stream and an audio stream. The video streams of the first and second OTT stream are output to the display device 280 and respectively displayed on windows 292c and 292d of the multiview screen 290. One of the audio streams (e.g., one of the first OTA stream, the second OTA stream, the first OTT stream, and the second OTT stream) is output to the audio device 282 according to user input/selection. The presentation of the video streams of the first and second OTA streams as well as the first and second OTT streams may be synchronized. The video stream and the audio stream may also be synchronized for the corresponding media stream.

It should be noted that the multiview examples 300A-300D described above are for illustrative purposes only. Other multiview layouts and combinations of the OTA streams and OTT streams are also possible within the scope of the present disclosure. The multiview disclosed herein allows the user to independently select an OTT or OTA channel for each window 292 of the multiview screen 290. For example, the user can freely switch the channel for window 292a, and in response, the tuner 204a is tuned to the new channel selected by the user. The tuner then outputs an OTA stream corresponding to the new channel for display in window 292a. This operation occurs without interfering with the presentation of the media streams in other windows, such that each window 292 displays its selected OTA or OTT stream independently and concurrently.

FIG. 4 is a pictorial diagram that illustrates an exemplary view of a user interface 400 for multiview according to embodiments described herein. The user interface 400 is displayable on the display device 280 of the television 116. The user interface 400 may include multiview layout selection panel 410, a multiview channel selection panel 420, and various interactive controls (e.g., virtual buttons or actuators) such as channel selection 430, channel guide 440, audio selection 450, recording selection 460, among others.

The multiview layout selection panel 410 provides various multiview templates 412 and a custom control 414. Users can select, for example, using the remote control 262, various templates 412 and also customize the number of windows, the size of each window, and the layout of multiple windows through the use of the custom control 414.

The multiview window selection panel 420 allows the user to select a window 422 of the multiview template and determine a channel for the selected window 422. For example, the user can browse the list of OTT channels and OTA channels through use of channel selection 430 and the channel guide 440. The channel selection 430 allows users to change the channel being viewed in a selected window. Users can navigate through available OTT and OTA channels and select a new channel to display in the highlighted window 422. The channel guide 440 provides a program guide for OTA and OTT channels, displays scheduling information, program descriptions, and upcoming shows for all available channels. Users can browse the program guide to help decide what to watch or record. Audio selection 450 manages audio output from the multiview screen. Users can select a window for outputting audio stream corresponding to the media stream for the selected window. Recording selection 460 allows the use to record selected channel or window and provides options to record the content being displayed in one or more windows. Users can initiate, stop, or schedule recordings for both OTA and OTT streams displayed in the windows.

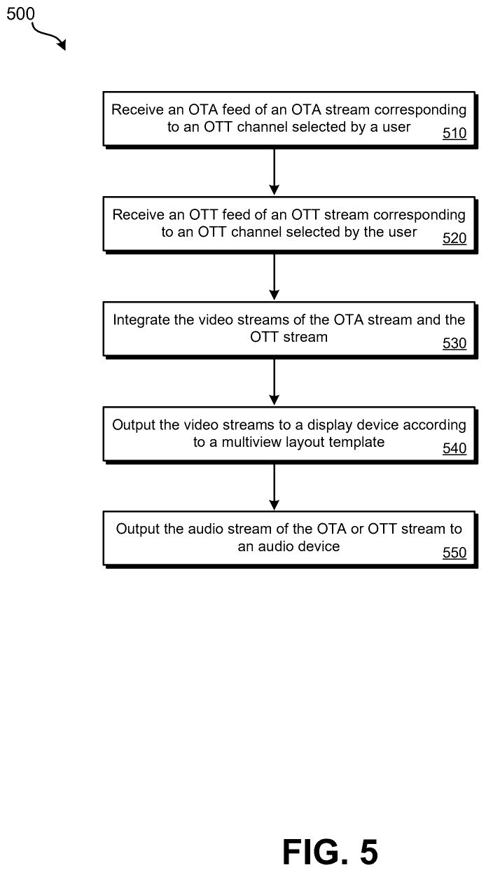

FIG. 5 is a flow diagram illustrating an example method 500 for multiview of media streams according to embodiments described herein. Method 500 may be performed by one or more components of the system, device, or via the use of the user interface as illustrated in FIGS. 1-2, 3A-3D, and 4. Method 500 includes process blocks illustrated in FIG. 5. Depending on the implementation, method 500 may include additional, fewer, or alternative process blocks performed in various orders or in parallel.

At 510, an OTA stream is received, by a media device, in response to a user request for viewing an OTA channel corresponding to the OTA stream. In some embodiments, a tuner of the media device is tuned to the OTT channel for receiving an OTA feed of the OTA stream and outputting the OTA stream. In some embodiments, the OTA feed is further processed by the media device for outputting. For example, the OTA feed received in the media device may be encoded or encrypted, and the encoded OTA feed can be decoded and decrypted by the media device to generate the OTA stream for outputting. The OTA stream further includes a video stream and a corresponding audio stream.

At 520, an OTT stream is received, by the media device, in response to a user request for viewing an OTT channel corresponding to the OTT stream. An OTT feed comprising data packets of media content corresponding to the OTT channel is received in OTT receiver of the media device for outputting the OTT feed as the OTT stream. The OTT stream further includes a video stream and a corresponding audio stream.

At 530, the video stream of the OTA stream and the video stream of the OTT stream are integrated/combined by the media device for concurrent presentation. At 540, the combined video streams are output by the media device to a display device of a media presentation device according to a multiview layout template selected by the user. The multiview layout template includes a first window and a second window. The video stream of the OTA stream is presented/displayed in the first window and the video stream of the OTT stream is presented/displayed in the second window. The video streams of the OTT stream and the OTA stream are synchronized.

At 550, the audio stream of one of the OTT stream and OTA stream selected by the user is output to an audio device of the media presentation device. In some embodiments, the OTT stream or the OTA stream being presented in one or both of the windows of the multiview screen is recorded, by the media device, in response to a user request. The audio stream output to the audio device may be changed by the media device in response to user request.

In some embodiments, a user request for a second OTA channel for the first window is received. In response, the presentation of the OTA stream in the first window is terminated in response to the user request, and a second OTA stream corresponding to the second OTA channel is received and output to the first window, while the OTT stream is presenting on the second window. Presentations of the second OTA stream and the OTT stream in the multiview screen are synchronized. In some embodiments, a user request for a second OTT channel for the second window is received. In response, the presentation of the OTT stream in the second window is terminated in response to the user request, and a second OTT stream corresponding to the second OTT channel is received and output to the first window, while the OTA stream is presenting in the first window. Presentations of the second OTA stream and the OTT stream in the multiview screen are synchronized.

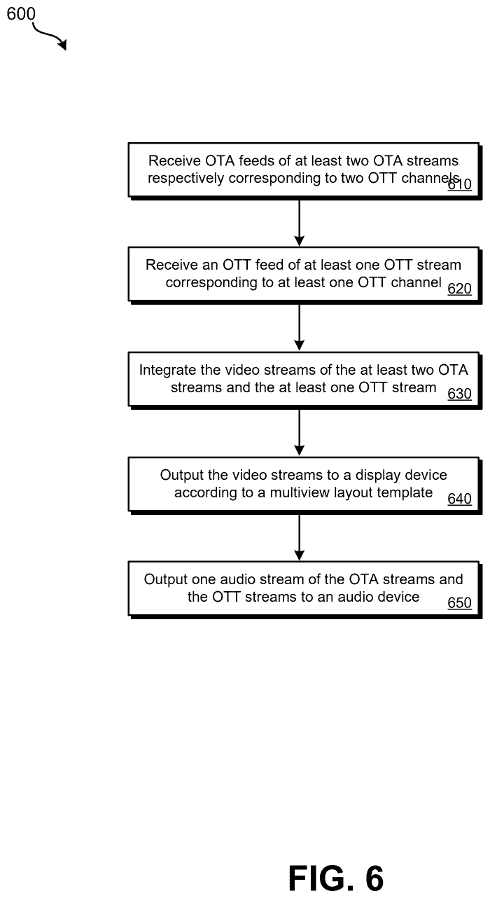

FIG. 6 is a flow diagram illustrating an example method 600 for multiview of media streams according to embodiments described herein. Method 600 is a variation of method 500. Depending on the implementation, method 500 may include additional, fewer, or alternative process blocks performed in various orders or in parallel.

At 610, at least two OTA streams are received by a media device, in response to a user request for viewing at least two OTA channels respectively corresponding to the OTA streams. In some embodiments, two OTA streams are received. A first tuner of the media device is tuned to the first OTT channel and receive an OTA feed of the first OTA stream. A second tuner of the media device is tuned to the second OTT channel and receive an OTA feed of the second OTA stream. In some embodiments, three OTA streams are received by tuning three tuners of the media device respectively to three OTA channels selected by the user. Each OTA stream further includes a video stream and a corresponding audio stream.

At 620, at least one OTT stream is received, by the OTT receiver of the media device, in response to a user request for viewing at least one OTT channel corresponding to the at least one OTT stream. In some embodiments, an OTT feed comprising data packets of media content corresponding to the OTT channel is received in OTT receiver of the media device for outputting the OTT stream. In some embodiments, two OTT channels are requested by the user, and two OTT feeds each comprising data packets of media content corresponding to the OTT channel are received in OTT receiver of the media device respectively for outputting the two OTT streams. Each OTT stream further includes a video stream and a corresponding audio stream.

At 630, the video streams of the at least two OTA streams and the video stream of the at least one OTT stream are integrated/combined by the media device for concurrent presentation. At 640, the combined video streams are output by the media device to a display device of a media presentation device according to a multiview layout template selected by the user. The multiview layout template includes at least three windows. The video streams of the at least two OTA streams are respectively presented/displayed in at least two windows of the multiview layout template and the video stream of the at least one OTT stream is presented/displayed in at least one of the windows of the multiview layout template. The video streams of the at least two OTA streams and the at least one OTT stream are synchronized. In some embodiments, two OTA streams and one OTT stream are concurrently presented in three windows of the multiview layout template according to user selection. In some embodiments, three OTA streams and one OTT stream are concurrently presented in four windows of the multiview layout template according to user selection. In some embodiments, two OTA streams and two OTT streams are concurrently presented in four windows of the multiview layout template according to user selection.

At 650, the audio stream of one of the at least two OTA streams and the at least one OTT stream selected by the user is output to an audio device of the media presentation device. In some embodiments, the OTT stream or the OTA stream being presented in one or more of the windows of the multiview screen is recorded, by the media device, in response to a user request. The audio stream output to the audio device may be changed by the media device in response to user request.

In some embodiments, a user request for a new OTA channel for a selected window of the multiview layout is received. In response, the presentation of the video stream of the OTA stream in the selected window is terminated in response to the user request, and a new OTA stream corresponding to the new OTA channel is received and output to the selected window, while the other OTA stream(s) and the OTT stream are presenting on the other windows without disruption. Presentations of the new OTA stream and the other OTA stream(s) as well as the OTT stream in the multiview screen are synchronized.

In some embodiments, a user request for a new OTT channel for a selected window of the multiview layout is received. In response, the presentation of the OTT stream in the selected window is terminated in response to the user request, and a new OTT stream corresponding to the new OTT channel is received and output to the selected window, while the OTA streams and/or other OTT stream(s) are presenting on the other windows without disruption. Presentations of the new OTT stream and the OTA streams as well as the other OTT stream(s) in the multiview screen are synchronized.

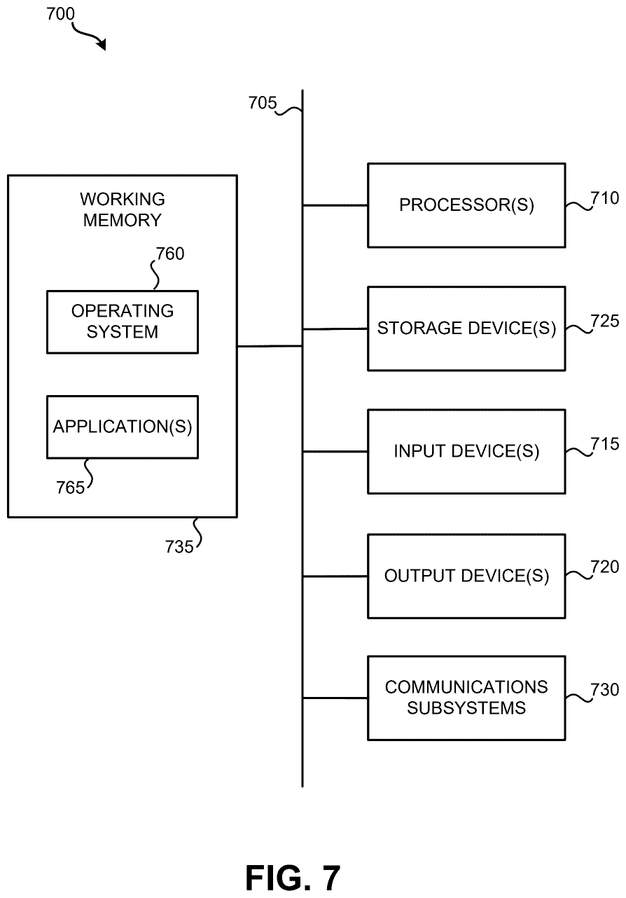

The systems 100 and 200 and any components thereof, such as the media device 202 and television 116, etc., described above may include a computer system that further includes computer hardware and software that form special-purpose network circuitry to implement various embodiments such as communication, receiving or outputting media streams, selection, identification, determination, and other operations or steps of the methods or processes described herein. FIG. 7 is a schematic diagram illustrating an example of computer system 700. The computer system 700 is a simplified computer system that can be used to implement various embodiments described and illustrated herein. FIG. 7 provides a schematic illustration of one embodiment of a computer system 700 that can perform some or all of the steps of the methods and workflows provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown including hardware elements that can be electrically coupled via a bus 705, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 715, which can include without limitation a mouse, a keyboard, a camera, and/or the like; and one or more output devices 720, which can include without limitation a display device, a printer, and/or the like.

The computer system 700 may further include and/or be in communication with one or more non-transitory storage devices 725, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 730 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 730. In other embodiments, a portable electronic device, e.g., the first electronic device, may be incorporated into the computer system 700, e.g., an electronic device as an input device 715. In some embodiments, the computer system 700 will further include a working memory 735, which can include a RAM or ROM device, as described above.

The computer system 700 also can include software elements, shown as being currently located within the working memory 735, including an operating system 760, device drivers, executable libraries, and/or other code, such as one or more application programs 765, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 7, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 725 described above. In some cases, the storage medium might be incorporated within a computer system, such as computer system 700. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 700 to perform methods in accordance with various embodiments of the technology. According to a set of embodiments, some or all of the operations of such methods are performed by the computer system 700 in response to processor 710 executing one or more sequences of one or more instructions, which might be incorporated into the operating system 760 and/or other code, such as an application program 765, contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 and/or components thereof generally will receive signals, and the bus 705 then might carry the signals and/or the data, instructions, etc. carried by the signals to the working memory 735, from which the processor(s) 710 retrieves and executes the instructions. The instructions received by the working memory 735 may optionally be stored on a non-transitory storage device 725 either before or after execution by the processor(s) 710.

The methods, process, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

1. A media device, comprising:
an over-the-air (OTA) receiver comprising a tuner;
an over-the-top (OTT) receiver;
one or more processors; and
a computer-readable storage media storing computer-executable instructions, wherein, the instructions when executed by the one or more processors,
cause the OTA receiver to tune the tuner to an OTA channel selected by a user to receive an OTA stream corresponding to the OTA channel, the OTA stream comprising a video stream and an audio stream;
cause the OTT receiver to receive an OTT stream, the OTT stream corresponding to an OTT channel selected by the user and comprising a video stream and an audio stream;
cause the OTT receiver to display a multiview layout selection panel including a plurality of multiview layout templates;
receive a user input indicating a selected multiview layout template of the plurality of multiview layout templates;
cause the media device to output the video stream of the OTA stream and the video stream of the OTT stream to a display device of a media presentation device, according to the selected multiview layout template, the selected multiview layout template comprising a first window and a second window; and
cause the video stream of the OTA stream and the video stream of the OTT stream to be concurrently presented in the first window and the second window, respectively.

2. The media device of claim 1, wherein the instructions when executed by the one or more processors further cause the media device to:
output the audio stream of either the OTA stream or the OTT stream to an audio device of the media presentation device.

3. The media device of claim 1, wherein the instructions when executed by the one or more processors further cause the media device to:
synchronize the video stream of OTA stream and the video stream of the OTT stream for output.

4. The media device of claim 1, wherein the instructions when executed by the one or more processors further cause the media device to:
record the OTA stream output to the media presentation device while the video stream of the OTT stream is being presented in response to a user request;
record the OTT stream output to the media presentation device while the video stream of the OTA stream is being presented; or
record both the OTT stream and OTA stream output to the media presentation device while the video stream of the OTT stream and the video stream of the OTA stream are being concurrently presented.

5. The media device of claim 1, wherein the instructions when executed by the one or more processors further cause the media device to:
in response to a user request for switching the OTA channel to a new OTA channel, cease outputting the video stream of the OTA stream;
tune the tuner to the new OTA channel to receive a new OTA stream comprising a video stream and an audio stream;
output the video stream of the new OTA stream to the display device; and
cause the video stream of the new OTA stream to be presented in the first window while the OTT stream is presented in the second window.

6. The media device of claim 1, wherein the instructions when executed by the one or more processors further cause the media device to:
in response to a user request for switching the OTT channel to a new OTT channel, cease outputting the video stream of the OTT stream;
cause the OTT receiver to receive a new OTT stream corresponding to the new OTT channel, the new OTT stream comprising a video stream and an audio stream;
output the video stream of the new OTT stream to the display device; and
cause the video stream of the new OTT stream to be presented in the second window while the OTA stream is presented in the first window.

7. A media device, comprising:
an over-the-air (OTA) receiver comprising a plurality of tuners;
an over-the-top (OTT) receiver;
one or more processors; and
a computer-readable storage media storing computer-executable instructions, wherein, the instructions when executed by the one or more processors,
cause the OTA receiver to tune, respectively, a first tuner and a second tuner of the plurality of tuners to a first OTA channel and a second OTA channel selected by a user and receive a first OTA stream and a second OTA stream respectively corresponding to the first and second OTA channel, each one of the first and second OTA streams comprising a video stream and an audio stream;
cause the OTT receiver to receive a first OTT stream, the first OTT stream corresponding to a first OTT channel selected by the user and comprising a video stream and an audio stream;
cause the OTT receiver to display a multiview layout selection panel including a plurality of multiview layout templates;
receive a user input indicating a selected multiview layout template of the plurality of multiview layout templates;
cause the media device to output the video streams of the first and second OTA streams and the video stream of the first OTT stream to a display device of a media presentation device, according to the selected multiview layout template, the selected multiview layout template comprising a first window, a second window, and a third window; and
cause the video streams of the first and second OTA streams and the video stream of the first OTT stream to be concurrently presented in the first, second, and third window, respectively.

8. The media device of claim 7, wherein the instructions when executed by the one or more processors further cause the media device to:
output the audio stream of one of the first OTA stream, the second OTA stream, and the first OTT stream to an audio device of the media presentation device.

9. The media device of claim 7, wherein the instructions when executed by the one or more processors further cause the media device to:
synchronize the video streams of the first and second OTA streams and the video stream of the first OTT stream for output.

10. The media device of claim 7, wherein the selected multiview layout template further comprises a fourth window, and the instructions when executed by the one or more processors further:
cause the tuner to tune a third tuner the plurality of tuners to a third OTA channel selected by the user and receive a third OTA stream corresponding to the third OTA channel, the third OTA stream comprising a video stream and an audio stream;
cause the media device to output the video stream of the third OTA stream to the display device according to the selected multiview layout template; and
cause the video stream of the third OTA stream to be presented in the fourth window while the video streams of the first and second OTA streams and the video stream of the OTT stream are presented.

11. The media device of claim 7, wherein the selected multiview layout template further comprises a fourth window, and the instructions when executed by the one or more processors further:
cause the OTT receiver to receive a second OTT stream corresponding to a second OTT channel selected by the user, the second OTT stream comprising a video stream and an audio stream;
cause the media device to output the video stream of the second OTT stream to the display device according to the selected multiview layout template; and
cause the video stream of the second OTT stream to be presented in the fourth window while the video streams of the first and second OTA streams and the video stream of the OTT stream are presented.

12. A method performed by a media device, the method comprising:
tuning, by a first tuner and a second tuner of the media device, to a first OTA channel and a second OTA channel selected by a user and receiving a first OTA stream and a second OTA stream respectively corresponding to the first and second OTA channel, each one of the first and second OTA streams comprising a video stream and an audio stream;
receiving, by an OTT receiver of the media device, a first OTT stream corresponding to a first OTT channel selected by the user and comprising a video stream and an audio stream;
causing the OTT receiver to display a multiview layout selection panel including a plurality of multiview layout templates;
receiving a user input indicating a selected multiview layout template of the plurality of multiview layout templates;
outputting the video streams of the first and second OTA streams and the video stream of the first OTT stream to a display device of a media presentation device, according to selected multiview layout template, the selected multiview layout template comprising a first window, a second window, and a third window; and
causing the video streams of the first and second OTA streams and the video stream of the first OTT stream to be concurrently presented in the first, second, and third window, respectively.

13. The method of claim 12, further comprising:
outputting the audio stream of one of the first OTA stream, the second OTA stream, and the first OTT stream to an audio device of the media presentation device.

14. The method of claim 12, further comprising:
synchronizing the video streams of the first and second OTA streams and the video stream of the first OTT stream for output.

15. The method of claim 12, wherein the selected multiview layout template further comprises a fourth window, and the method further comprises:
tuning a third tuner of the media device to a third OTA channel selected by the user and receive a third OTA stream corresponding to the third OTA channel, the third OTA stream comprising a video stream and an audio stream;
outputting the video stream of the third OTA stream to the display device according to the selected multiview layout template; and
causing the video stream of the third OTA stream to be presented in the fourth window while the video streams of the first and second OTA streams and the video stream of the OTT stream are presented.

16. The method of claim 12, wherein the selected multiview layout template further comprises a fourth window, and the method further comprises:
causing the OTT receiver to receive a second OTT stream corresponding to a second OTT channel selected by the user, the second OTT stream comprising a video stream and an audio stream;
outputting the video stream of the second OTT stream to the display device according to the selected multiview layout template; and
causing the video stream of the second OTT stream to be presented in the fourth window while the video streams of the first and second OTA streams and the video stream of the OTT stream are presented.

17. The method of claim 12, further comprising:
in response to a user request received in the media device, recording the first OTA stream output to the media presentation device while the video stream of the second OTA stream and the OTT stream are being presented in response to a user request.

18. The method of claim 12, further comprising:
in response to a user request received in the media device, recording the first OTA stream and the second OTA stream output to the media presentation device while the video stream of the OTT stream is being presented in response to a user request.

19. The method of claim 12, further comprising:
in response to a user request for switching the first OTA channel to a new OTA channel, ceasing outputting the video stream of the first OTA stream;
tuning the tuner to the new OTA channel to receive a new OTA stream comprising a video stream and an audio stream;
outputting the video stream of the new OTA stream to the display device; and
causing the video stream of the new OTA stream to be presented in the first window while the second OTA stream and the OTT stream are being respectively presented in the second window and third window.

20. The method of claim 12, further comprising:
in response to a user request for switching the OTT channel to a new OTT channel, ceasing outputting the video stream of the OTT stream;
causing the OTT receiver to receive a new OTT stream corresponding to the new OTT channel, the new OTT stream comprising a video stream and an audio stream;
outputting the video stream of the new OTT stream to the display device; and
causing the video stream of the new OTT stream to be presented in the third window while the first OTA stream and the second OTA stream are respectively presented in the first window and the second window.
